(19) United States
(12) Patent Application Publication
(10) Pub. No.: US 2001/0033561 A1
(43) Pub. Date: Oct. 25, 2001

(54) Combination switch and routing-switching radio base station

(75) Inventor: Gunnar Rodin, Bettna (SE)

Correspondence Address: Jenkens & Gilchrist, P.C., Suite 3200, 1445 Ross Avenue, Dallas, TX, 75202, US

(73) Assignee: Telefonaktiebolaget L M Ericsson ( publ).

(21) Appl. No.: 09/765,171

(22) Filed: Jan. 18, 2001

Related U.S. Application Data
(60) Provisional application No. 60/177,805, filed on Jan. 25, 2000.

(51) Int. Cl. H04Q 7/24

(52) U.S. Cl. 370/338; 370/352; 370/401

(57) ABSTRACT

A combination switch including a time slot switch and a router for receiving circuit-switched and Internet Protocol packet data.

A routing-switching base station in electronic communication with a telecommunications network includes a combination time slot switch and Internet Protocol switch, along with a plurality of transceivers. Circuit-switched data and Internet Protocol packet data received from the network and is passed on to the transceivers. The combination switch may include a time slot switch and a router.

A routing radio base station includes a router in electronic communication with a plurality of transceivers.

### REFERENCE TO RELATED APPLICATIONS

This application claims the benefit of priority from copending U.S. Provisional Application for Pat. No. 60/177,805 titled “IP Packet Router Integrated into a Radio Base Station” filed on Jan. 25, 2000, is related thereto, is commonly assigned therewith, and the subject matter thereof is incorporated herein by reference in its entirety.

### BACKGROUND OF THE INVENTION

1. Technical Field of the Invention

The present invention relates in general to the telecommunications field and, in particular, to an apparatus providing both circuit-switched and packet-switched communications within a telecommunications network.

2. Description of Related Art

Radio base stations (RBSs) within a mobile telephony system are often used as network traffic transmission transfer points to other base stations. Commonly used network topologies for connecting such base stations to each other include the chain, ring, and tree topologies. A single transmission link typically operates at rates of 2, 4, or 8 Mbit/second, which is greater than what is used by a single base station. Therefore, multiple base stations often use a single transmission link. Since the physical transmission medium is usually a radio link, base station sites often house radio link equipment as well.

Each base station is typically connected to the transmission network with one or more physical transmission links. The number of links depends on the desired network topology, requirements for redundancy, and the need for transmission capacity at the base station. In a circuit-switched network 9, an internal switch matrix is used to distribute fractions of connected bandwidth transmissions within the base station to various transceivers and other signaling devices. The built-in switch matrix is sometimes also used for switching excess bandwidth to another link in the transmission network. This link is then used for connection to other base stations. As shown in the prior art network block diagram of FIG. 1A, a string of cascaded Internet nodes 20 and radio base stations 30 are connected via network ports 32 within a network 10, such as a combination Internet Protocol (IP) network 8 and a switching network 9. In the network 10 topology shown in FIG. 1, circuit-switched (STM) RBSs 30 are connected to Internet nodes 20. This type of mixed network 10 is a common migration scenario as users migrate from a completely circuit-switched network to an IP network. However, the flexibility provided by packet switched connections and the IP Suite in combination with circuit-switched networks requires a change in switching technology. A converter 80 may be needed to convert signals between the circuit-switched network 9 and the IP network 8.

Each RBS 30 is typically controlled by a Base Station Controller (BSC) 40, and is connected to the controller 40 using a control/traffic port 31. For example, the BSC 40 keeps track of resources within the STM RBS 30. Such resources include the number and type of radio transceivers, and the number and type of internal switching connections. The connections within the switch 50 are known as “circuit-switched connections.” The switch 50 setup (i.e., how time slots within a time frame 72 are switched) is accomplished using the BSC 40. Thus, it is the job of the BSC 40 to track resources within the base station, which include transceivers 60, 61 and connections within the switch 50. Once the connections within the switch 50 are set, they are usually not changed unless there is a disturbance within the transmission network 10 or the STM RBS 30 is shut down. The BSC 40 is also the source/destination for connections to from the RBS 30.

The transmission interface, such as a 2 Mbit/sec G.703 interface, delivers data in 32 byte frames 72, typically divided into one byte time slots 74. The switch 50 switches all time slots that have the same position in the frame 72 to one internal destination. For example, considering the circuit-switched transceivers 60, 61, the switch 50 may elect to send time slots #4 and #5, 76, 78, in each frame 72 to the transceiver 61 via internal interface connection 70.

The typical messages which are used to load IP networks include e-mail, file transfer, and accesses to the world-wide web. The length of these messages, which are divided into packets 82, is often a few hundred bytes, on up to a thousand or more bytes. For mobile radio systems, on the other hand, speech packets are typically used to load the network. These packets are quite small (i.e., on the order of 40-60 bytes) but are transmitted rapidly (i.e., about every 20 milliseconds. This disparity in packet size and frequency of transmission influences the optimal design and routing elements within a mixed network 10.

IP packets 82 from the nodes 20 can only be inserted into available time slots within the frames 72, which may require the use of a converter 80. Thus, IP-formatted information (i.e., packets 82) can be sent to the BSC 40 without changing the operational characteristics of the switch 50. In this way, IP-formatted data can be switched without routing, which is inefficient.

As mentioned previously, the current solution is to divide the available bandwidth into small selected portions (i.e., one or more time slots) and assign them to each base station. However, when packet transmissions are used within the mixed network 10, it is inefficient to divide the link bandwidth into fractions (i.e., one or more consecutive time slots) reserved to different base stations 30. The bandwidth for each device or base station is thus reserved, and cannot be reused by other devices. Thus, the transfer time for individual packets will be fairly long if only a few time slots are used.

Thus, in mixed networks 10, there is a need for efficient data distribution between RBSs 30 and the BSC 40. This need is independent of the transmission network used. For migration from a circuit-switched network 9 to an IP network 8, it should also be possible to mix IP routing and STM switching.

A related problem is illustrated in prior art FIG. 1B. Sending packet data 82 in an all-IP network 12 using conventional RBSs 30 requires an additional router 65, which adds cost and requires space. Thus, a solution which obviates the need for the router 65 to communicate packet data to RBSs 30 in an all-IP network 12 is also needed.

### SUMMARY OF THE INVENTION

In accord with one embodiment of the present invention, a combination switch includes a time slot switch and a router. The combination switch is in electronic communication with the telecommunications network providing frames of circuit-switched data and packets of IP data, such that the time slot switch receives the circuit-switched data, and the router receives the IP data. The router is in electronic communication with the time slot switch.

The combination switch may include one or more central processing units and one or more digital signal processors. Typically, the central processing unit communicates with the time slot switch and the router while executing one or more network management protocols, such as the Simple Network Management Protocol (SNMP). Typically, a digital signal processor is used to implement the time slot switch, and another digital signal processor is used to implement the router.

In another embodiment, the invention includes a routing-switching base station, which may be a radio base station, having a combination time slot switch and Internet Protocol switch (or separate time slot switch and router elements), in electronic communication with a plurality of transceivers. The base station is in electronic communication with a telecommunications network providing frames of circuit-switched data and packets of IP data. The combination switch receives the data, and sends it on to the plurality of transceivers.

In an alternative embodiment, a routing radio base station of the present invention includes a router for receiving one or more packets of IP data from the network, along with a plurality of transceivers which are in electronic communication with the router. As the combination routing-switching base station migration solution is incorporated into networks over time, the need for the router and time slot switch combination is expected to give way to the router radio base station incorporating only the router.

### BRIEF DESCRIPTION OF THE DRAWINGS

A more complete understanding of the method and apparatus of the present invention may be had by reference to the following detailed description when taken in conjunction with the accompanying drawings wherein:

FIGS. 1A and 1B, previously described, are prior art block diagrams of a mixed network and all-IP network, respectively;

FIGS. 2A and 2B are block diagrams of the routing-switching base station and the routing radio base station, respectively, of the present invention; and

FIG. 3 is a schematic block diagram of the combination switch of the present invention.

### DETAILED DESCRIPTION OF THE DRAWINGS

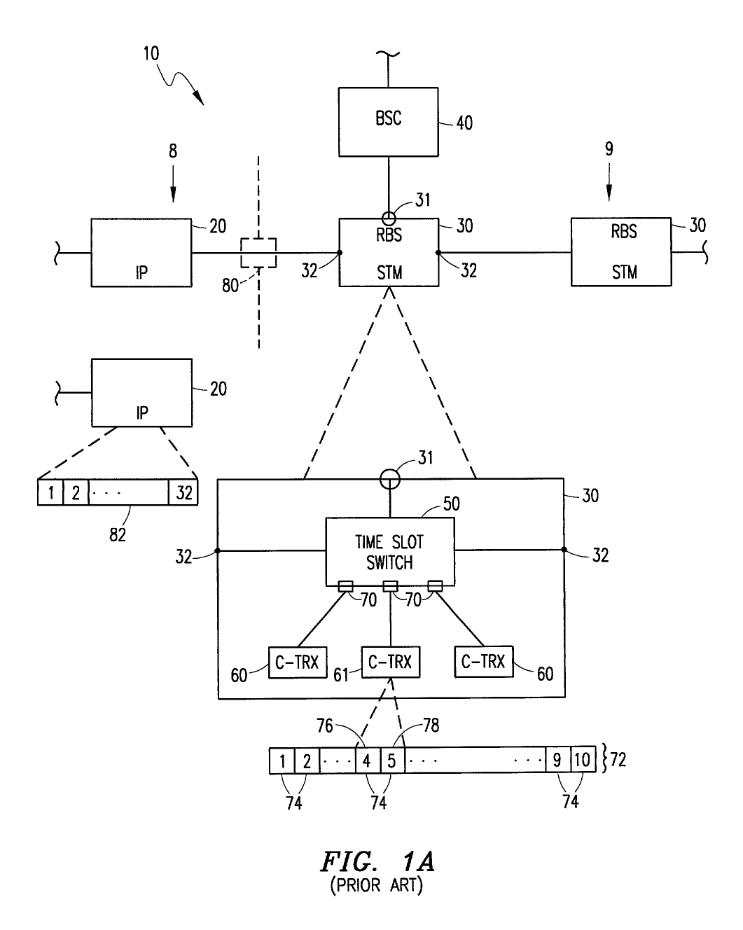

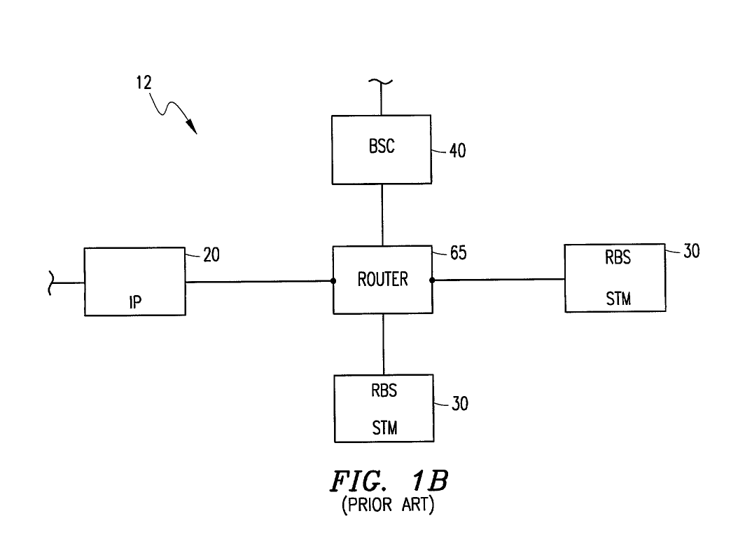

The preferred embodiment of the present invention and its advantages are best understood by referring to FIGS. 1-3 of the drawings, like numerals being used for like and corresponding parts of the various drawings.

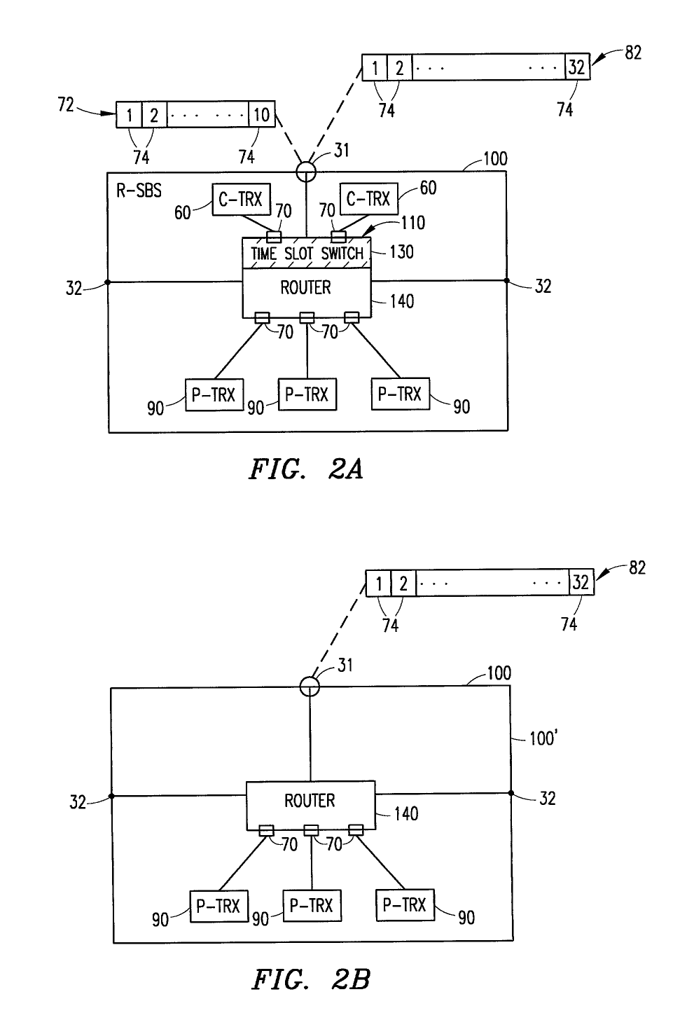

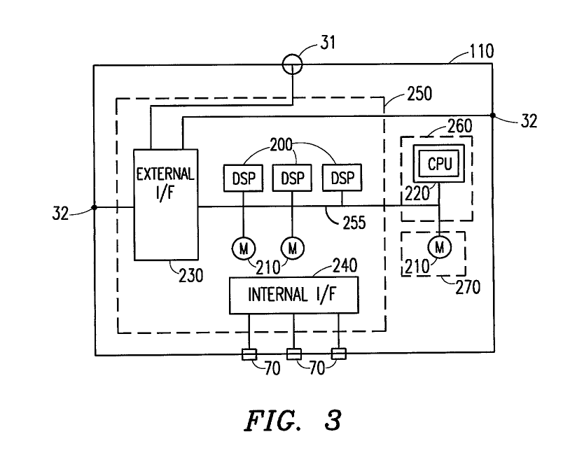

Turning now to FIG. 2A, the routing-switching base station 100 of the present invention can be seen. Included within the base station 100, which may be a radio base station, is a combination time slot switch and Internet Protocol switch 110, which may comprise a time slot switch 130 and a router 140. Through a series of internal interface connections 70, the combination switch 110 is placed into electronic communication with a plurality of transceivers 60, 90. The transceivers may be radio frequency transceivers, optical transceivers, or other transceivers which operate using electromagnetic energy to communicate information. Thus, when a network supplies frames 72 of circuit-switched data to the base station 100, they may be received by the combination switch 110, and selected portions of the frames 72 can be sent on to the transceivers 60. Similarly, when packets 82 are received from the network, the IP data packets 82 can be sent on to the transceivers 90. The transceivers 60, 90 may be similar or identical. The numeric differentiation is (only) used to show that either transceiver 60, 90 may be used to send/receive frames 72 or selected packets 82 of data.

The combination switch 110 (or the individual elements of a time slot switch 130 and a router 140) located in the routing-switching base station 100 is a network migration solution that lends itself to use in mixed networks having a combination of legacy equipment that operates only with circuit-switched data, and newer equipment that operates using packet-switched data. However, as time goes on, and the use of antiquated circuit-switched equipment disappears, the routing-switching base station 100, which may be a radio base station, will not require circuit switching functionality. The resulting routing radio base station 100′ will include the router 140 and one or more transceivers 90 in electronic communication with the router 140, but not a time slot switch 130. This solution, shown in FIG. 2B, solves the problem shown in FIG. 1B, wherein an extra router 65 is needed to interface conventional RBSs 30 to the all-IP network 12. In the invention, the equivalent of router 65, i.e., router 140, is now included within the routing radio base station 100′.

Thus, a cost efficient solution is provided by the present invention to replace the built-in switch matrix 50 of prior art base stations 30. The new (replacement) combination switch 110 is capable of acting as a packet router, as a circuit switch, or as a device which can provide packet-switching and circuit-switching at the same time. The integrated device (i.e., switch) 110 is able to terminate traffic bound for the base station 100, to forward traffic bound for other base stations, and to distribute traffic internally within the base station 100. The router 140 within the switch 110 is programmed to understand and implement the IP Suite.

The switch 110 (or the router 140 alone) can be implemented using various logical building elements, and is not meant to be limited by the exemplary illustrations given herein. For example, as shown in FIG. 3, the switch 110 can be implemented using a central processing unit 260 and one or more digital signal processing units 200. Using such a combination of logical building elements provides several advantages. Central processing units have a flexible construction set and can address large amounts of memory. Thus, such central processing units are suitable to process programs that are not time critical, and require complex instruction sets. These units are relatively inexpensive, and it is possible to combine multiple central processing units in a cluster to achieve higher data processing rates.

On the other hand, Digital Signal Processors (DSPs) typically have a specialized instruction set, and access less memory than that which can be accessed by a central processing unit. Thus, DSPs are suitable to process programs that are time critical, and require relatively unsophisticated program instructions. DSPs can also be clustered to provide increased throughput.

The various elements of the combination switch 110 can be grouped into integrated circuits, such as a first integrated circuit 250, a second integrated circuit 260, and a third integrated circuit 270. Thus, in the exemplary implementation of the combination switch 110 shown in FIG. 3, the first integrated circuit 250 may contain three DSPs 200 communicating with two memories 210, an external interface 230, and an internal interface 240 using a common internal bus 255. The bus 255 is also connected to the central processing unit 220, located on the second integrated circuit 260. The memory 210 within the third integrated circuit 270 is also connected to the bus 255. Of course integrated circuits 250, 260 and 270 can all be further integrated into a single circuit (not shown).

In the combination switch 110 configuration shown in FIG. 3, the circuitry within the second integrated circuit 260 (i.e., the central processing unit 220) can communicate using Direct Memory Access (DMA) with the DSPs 200 and the memories 210 located in the first integrated circuit 250. Another bus (not shown in FIG. 3) may be used for DSP 200 instruction fetches from the memories 210, or other memories (not shown). The integrated circuit 250 may also contain special hardware and/or firmware for High-level Data Link Control (HDLC) protocol conversion. In the exemplary configuration of FIG. 3, the time slot switch 130 may be implemented using the interfaces 230, 240, the memories 210, and programs in two of the three DSPs 200. The remaining DSP 200 (and excess capacity of the other DSPs 200) and the central processing unit 220 and the DSPs 200 are used to execute the IP Instruction Suite. Some of the routines needed for transferring a message through the combination switch 110, and executed within the DSPs 200, might include HDLC controls, Point-to-Point Protocol (PPP), Link Control Protocol/Neighbor Discovery Protocol (LCP/NDP) for initiating PPP, multilink PPP, header compression, queuing (e.g., quality of service) and policing algorithms, packet forwarding IP, and the User Datagram Protocol (UDP). Typically, the memory 210 necessary for storing programs executed in the DSPs 200, along with the memory 210 needed for a data storage, will be a few hundred kilobytes. The DSPs should operate at a program execution speed of approximately one billion instructions per second (i.e., 1,000 Mips).

In the central processing unit 220, several protocols are required for setup, supervision, exception handling, etc. These include: IP Options Part, IP fragmentation, Open Shortest Path First (OSPF) routing protocol, and the Simple Network Management Protocol (SNMP). The memory 210 required by the central processing unit 220 should be on the order of several megabytes. The operating speed of the central processing unit will typically be about several million instructions per second (e.g., 1-10 Mips).

The routing-switching base station 100, the routing radio base station 100′, and the combination switch 110 allow implementation of inexpensive router functionality in the place of conventional radio base stations, which contain only circuit-switching operational elements. Such an implementation allows use of the combination switch as a general IP packet router at little or no additional cost.

The combination switch 110 can be used as an internal packet switch so that packets from different devices can share the entire bandwidth allowed. Thus, the combination switch 110 can use a portion of the bandwidth for the base station 100 for circuit switched data 72, and another portion of the bandwidth for packet-switched data 82. Using an internal router 140 for switching will provide faster packet transfer speeds and shorter queuing delays for high priority packets when priority mechanisms are used.

The combination switch 110 configuration also allows internal devices, such as transceivers 60, 90, to be addressed as IP nodes, and if desired, to be visible to the external network 10. Using a router 140 as an internal switching device operating under the IP Suite means that special, non-standard protocols, will not be needed to operate the switch 110.

Additional advantages of the switch 110 include automatic routing updates when the surrounding network 10 is changed (e.g., using the OSPF protocol); increased possibilities for plug-and-play base stations connected to a routing-switching base station 100; standardized supervision methods, operation, and maintenance (e.g., using the SNMP protocol); and standardized methods for verifying quality of service, policing, and resource allocation.

During migration operations, there will be the opportunity for connecting routing-switching base stations where circuit-switch connections are required. As noted above, in this case, circuit-switched data can use some fraction of the bandwidth, while IP routed data can use the remaining fraction of the bandwidth. Conversion routines from the IP and circuit-switch formats can be implemented using the combination switch 110 for direct interfacing to transceivers 60, 90. The functionality of the switch 110, implemented as described above, can now be changed using software so that the switch 110 can act as a time slot switch 130 alone, a combination switch 130, or a router 140 alone, and manual visits to the site of the switch 110 to change its function are obviated. Also, as noted above, the routing radio base station 100′ (see FIG. 2B) may only require the presence of a router 140 and transceivers 90 when circuit-switched data is no longer present in the network 10.

Finally, the DSPs 200 can operate as high performance packet switches, or as high performance circuit-switches. Circuit-switching and packet-switching can also be accomplished simultaneously. The same DSP 200 can perform internal distribution of data to various transceivers 60, 90 and other signaling devices. The DSPs 200 can also be assigned responsibility for internal data conversion (i.e., from circuit-switching protocols to IP, and vice versa). The DSPs 200 can also handle data routing and buffering, and administer Quality-of-Service functions within the IP Suite. The router 140 can also be used to concentrate several links that are lightly loaded into a single link for better utilization of available bandwidth.

Although a preferred embodiment of the method and apparatus of the present invention has been illustrated in the accompanying drawings and described in the foregoing detailed description, it will be understood that the invention is not limited to the embodiment disclosed, but is capable of numerous rearrangements, modifications and substitutions without departing from the scope of the invention as set forth and defined by the following claims.

What is claimed is:

1. A combination switch in electronic communication with a telecommunications network, wherein the telecommunications network includes at least one frame of circuit-switched data and at least one packet of Internet Protocol data, comprising:
a time slot switch for receiving the at least one frame of circuit-switched data; and
a router for receiving the at least one packet of Internet Protocol data in electronic communication with the time slot switch.

2. The combination switch of claim 1, further comprising:
at least one central processing unit in electronic communication with the time slot switch and the router.

3. The combination switch ofclaim 2, wherein the at least one central processing unit executes a network management protocol.

4. The combination switch of claim 2, wherein the time slot switch is implemented using at least one first digital signal processor in electronic communication with the at least one central processing unit.

5. The combination switch of claim 4, wherein the router is implemented using at least one second digital signal processor in electronic communication with the at least one central processing unit.

6. A routing-switching base station in electronic communication with a telecommunications network, wherein the telecommunications network includes at least one frame of circuit-switched data and at least one packet of Internet Protocol data, comprising:
a combination time slot switch and Internet Protocol switch for receiving the at least one frame of circuit-switched data and the at least one packet of Internet Protocol data; and
a plurality of transceivers, wherein each one of the plurality of transceivers is in electronic communication with the combination time slot switch and Internet Protocol switch.

7. The routing-switching base station of claim 6, wherein at least one of the plurality of transceivers receives a selected portion of the at least one frame of circuit-switched data from the combination time slot switch and Internet Protocol switch.

8. The routing-switching base station of claim 6, wherein at least one of the plurality of transceivers receives at least one packet of Intern et Protocol data from the combination time slot switch and Internet Protocol switch.

9. The routing-switching base station of claim 6, further comprising:
at least one central processing unit in electronic communication with the combination time slot switch and Internet Protocol switch.

10. The routing-switching base station of claim 9, wherein the at least one central processing unit executes a network management protocol.

11. The combination switch of claim 9, wherein the combination time slot switch and Internet Protocol switch is implemented using at least one digital signal processor in electronic communication with the at least one central processing unit.

12. The routing-switching base station of claim 6, wherein at least one of the plurality of transceivers is a radio frequency transceiver.

13. A routing-switching base station in electronic communication with a telecommunications network, wherein the telecommunications network includes at least one frame of circuit-switched data and at least one packet of Internet Protocol data, comprising:
a time slot switch for receiving the at least one frame of circuit-switched data;
a router in electronic communication with the time slot switch for receiving the at least one packet of Internet Protocol data; and
a plurality of transceivers, wherein at least one of the plurality of transceivers is in electronic communication with the time slot switch, and wherein at least one of the plurality of transceivers is in electronic communication with the Internet Protocol switch.

14. The routing-switching base station of claim 13, wherein the at least one of the plurality of transceivers in electronic communication with the time slot switch receives a selected portion of the at least one frame of circuit-switched data.

15. The routing-switching base station of claim 13, wherein at least one of the plurality of transceivers in electronic communication with the router receives at least one packet of Internet Protocol data.

16. The routing-switching base station of claim 13, further comprising:
at least one central processing unit in electronic communication with the time slot switch and the router.

17. The routing-switching base station of claim 16, wherein the at least one central processing unit executes a network management protocol.

18. The routing-switching base station of claim 13, wherein the time slot switch and the router are implemented using at least one digital signal processor in electronic communication with the at least one central processing unit.

19. The routing-switching base station of claim 13, wherein at least one of the plurality of transceivers is a radio frequency transceiver.

20. A routing radio base station in electronic communication with a telecommunications network, wherein the telecommunication network includes at least one packet of Internet Protocol data, comprising:
a router for receiving the at least one packet of Internet Protocol data; and
a plurality of transceivers, wherein each one of the plurality of transceivers is in electronic communication with the router.

21. The routing radio base station of claim 20, wherein at least one of the plurality of transceivers receives at least one packet of Internet Protocol data from the router.

22. The routing radio base station of claim 20, wherein the at least one central processing unit executes a network management protocol.

23. The routing radio base station of claim 20, wherein the router is implemented using at least one digital signal processor in electronic communication with the at least one central processing unit.
